(19) United States
(12) Patent Application Publication
(10) Pub. No.: US 2025/0114847 A1
(43) Pub. Date: Apr. 10, 2025

(54) ROTARY SHAFT CLAMP DEVICE

(71) Applicant: SHIBAURA MACHINE CO., LTD., Tokyo (JP)

(72) Inventors: Yusuke ISHII, Kanagawa (JP); Kazuhiro TAKEUCHI, Kanagawa (JP)

(73) Assignee: SHIBAURA MACHINE CO., LTD., Tokyo (JP)

(21) Appl. No.: 18/858,235

(22) PCT Filed: Jan. 30, 2023
(86) PCT No.: PCT/JP2023/002776

§ 371 Date: Oct. 18, 2024

(30) Foreign Application Priority Data
Apr. 20, 2022 (JP) 2022-069492

(51) Int. Cl. B23B 31/16

(52) U.S. Cl. CPC B23B 31/16275

(57) ABSTRACT

A rotary shaft clamp device configured to clamp a first member to a second member, the first and second members being relatively rotatable around a predetermined center axis, the rotary shaft clamp device including: a pair of contact surfaces annularly formed in an outer periphery of a disk provided for a rotary shaft that is a first member at a predetermined distance from the center axis and opposed to each other at a regular interval; and a press-contact member that is supported by a support body that is a second member and is configured to come into press-contact with the pair of contact surfaces, the press-contact member having a pair of surfaces located between the pair of contact surfaces to face the contact surfaces, the pair of surfaces being configured to advance in directions along the center axis.

### TECHNICAL FIELD

The present invention relates to a rotary shaft clamp device.

### BACKGROUND ART

In a working machine, a rotation dividing device is used for, for instance, adjustment of an orientation or inclination of a main shaft head of a multi-axis working machine or adjustment of an angular position of a rotary table.

The rotation dividing device is installed with a rotation driving device that causes a rotary shaft to rotate and a clamp device that restrains the rotary shaft at a predetermined angular position.

As the clamp device, a shaft-restraining device that restrains the rotary shaft or a disk-based device that restrains a disk attached to the rotary shaft is used.

The shaft-restraining device is exemplified by Patent Literature 1 and Patent Literature 2.

In the shaft-restraining rotary shaft clamp device, a diaphragm-based displacement mechanism is brought into press-contact with an outer periphery of the rotary shaft to frictionally apply a brake.

The disk-based device is exemplified by Patent Literature 3 and Patent Literature 4.

In the disk-based rotary shaft clamp device, a disk attached to the rotary shaft is fixed and a diaphragm-based displacement mechanism is brought into press-contact with a surface of the disk to frictionally apply a brake.

### CITATION LIST

### Patent Literature(s)

Patent Literature 1: JP 4996285 B
Patent Literature 2: JP 4883815 B
Patent Literature 3: JP 4993722 B
Patent Literature 4: JP 5078526 B

### SUMMARY OF THE INVENTION

### Problem(s) to be Solved by the Invention

The above-described disk-based device has a large distance from a rotation center to a restraining position, thus making it possible to enhance restraining force as compared with the shaft-restraining device.

However, in a case where press-contact force is applied to the disk only from one side of the disk, the rotary shaft suffers a load in a thrust direction (a direction of a rotation center axis), which affects positional accuracy as the rotation dividing device.

Thus, when press-contact force is to be applied from opposite surface sides of the disk to cancel the press-contact force on one side and the press-contact force on the opposite side, it is possible to reduce a displacement in the direction of the rotation center axis. However, in a case where respective displacement mechanisms such as diaphragms are installed on the opposite surface sides of the disk, there is an influence on the installation of the rotation dividing device, such as an increase in the number of parts or an increase in installation space.

An object of the invention is to provide a rotary shaft clamp device that ensures restraining force and positional accuracy with a simple structure.

### Means for Solving the Problem(s)

According to an aspect of the invention, there is provided a rotary shaft clamp device configured to clamp a first member to a second member, the first and second members being relatively rotatable around a predetermined center axis, the rotary shaft clamp device including: a pair of contact surfaces supported by the first member, the pair of contact surfaces being annularly formed at a predetermined distance from the center axis and opposed to each other at a regular interval; and a press-contact member supported by the second member, the press-contact member being configured to come into press-contact with the pair of contact surfaces, the press-contact member having a pair of surfaces located between the pair of contact surfaces to face the contact surfaces, the pair of surfaces being configured to advance in directions along the center axis.

In the rotary shaft clamp device according to the aspect of the invention, the first member may include a rotary shaft, the second member may include a support body by which the rotary shaft is rotatably supported, a disk may be concentrically formed at an intermediate portion of the rotary shaft, the pair of contact surfaces may be formed in an outer periphery of the disk and opposed in a direction of the center axis, and the press-contact member may be supported by the support body.

According to such an aspect of the invention, a basic configuration similar to that of an existing disk-based clamp device is applicable, and it is possible to restrain the rotary shaft with respect to the support body by virtue of the press-contact of the press-contact member with the contact surfaces and ensure restraining force by virtue of a large distance from the rotary shaft to the press-contact member.

Here, according to the aspect of the invention, the press-contact member is disposed between the pair of contact surfaces formed in the outer periphery of the disk, making it possible to simplify a structure as the clamp device. Further, the press-contact member comes into press-contact with the inner side of each of the contact surfaces provided as a pair to equalize the contact force to the contact surfaces. Thus, no force (thrust force) in the direction of the center axis attributed to the press-contact is generated in the rotary shaft, making it possible to ensure positional accuracy as a rotation mechanism.

In the rotary shaft clamp device according to the aspect of the invention, the first member may include a support body, the second member may include a rotary shaft rotatably supported by the support body, an annular contact member may be formed on an inner side of the support body, the contact member being concentric with the rotary shaft, the pair of contact surfaces may be formed in an inner side of the contact member and opposed in a direction of the center axis, and the press-contact member may be supported by the rotary shaft.

According to such an aspect of the invention, although the arrangement of the press-contact member and the contact surfaces is inverted to that of an existing disk-based clamp device, the press-contact of the press-contact member with the contact surfaces makes it possible to restrain the rotation relative to the support body and a large distance from the rotary shaft to the press-contact member makes it possible to ensure the restraining force.

Here, according to the aspect of the invention, the press-contact member is disposed between the pair of contact surfaces formed in the inner side of the annular contact member, making it possible to simplify a structure as the clamp device. Further, the press-contact member comes into press-contact with the inner side of each of the contact surfaces provided as a pair to equalize the contact force to the contact surfaces. Thus, no force (thrust force) in the direction of the center axis attributed to the press-contact is generated in the rotary shaft, making it possible to ensure positional accuracy as a rotation mechanism.

In the rotary shaft clamp device according to the aspect of the invention, the first member may include a rotary shaft, the second member may include a support body by which the rotary shaft is rotatably supported, a disk may be concentrically formed at an intermediate portion of the rotary shaft, the pair of contact surfaces may be formed in an outer edge of the disk and opposed in a radial direction of the rotary shaft, and the press-contact member may be supported by the support body.

According to such an aspect of the invention, the press-contact of the press-contact member with the contact surfaces makes it possible to restrain the rotary shaft with respect to the support body and a large distance from the rotary shaft to the press-contact member makes it possible to ensure the restraining force.

Here, according to the aspect of the invention, the press-contact member is disposed between the pair of contact surfaces formed in the outer edge of the disk and the press-contact member is disposed inside the outer periphery of the disk, making it possible to downsize and simplify a structure as the clamp device. Further, the press-contact member comes into press-contact with the inner side of each of the contact surfaces provided as a pair to equalize the contact force to the contact surfaces. Thus, no force (radial force) in the direction intersecting with the center axis attributed to the press-contact is generated in the rotary shaft, making it possible to ensure positional accuracy as a rotation mechanism.

In the rotary shaft clamp device according to the aspect of the invention, the first member may include a support body, the second member may include a rotary shaft rotatably supported by the support body, an annular contact member may be formed on an inner side of the support body, the contact member being concentric with the rotary shaft, the pair of contact surfaces may be formed along an inner edge of the contact member and opposed in a radial direction of the rotary shaft, and the press-contact member may be supported by the rotary shaft.

According to such an aspect of the invention, the press-contact of the press-contact member with the contact surfaces makes it possible to restrain the rotation with respect to the support body and a large distance from the rotary shaft to the press-contact member makes it possible to ensure the restraining force.

Here, according to the aspect of the invention, the press-contact member is disposed between the pair of contact surfaces formed in the inner edge of the contact member, and the press-contact member is disposed inside the outer periphery of the disk, making it possible to simplify a structure as the clamp device. Further, the press-contact member comes into press-contact with the inner side of each of the contact surfaces provided as a pair to equalize the contact force to the contact surfaces. Thus, no force (radial force) in the direction intersecting with the center axis attributed to the press-contact is generated in the rotary shaft, making it possible to ensure positional accuracy as a rotation mechanism.

In the rotary shaft clamp device according to the aspect of the invention, preferably, the press-contact member is flattened and includes a diaphragm expandable by a fluid pressure supplied inside.

According to the aspect of the invention, diaphragms are preferably formed on opposite surfaces of the flattened press-contact member. However, the diaphragm may be provided on one of the surfaces of the press-contact member. When the diaphragm is provided on one of the surfaces of the press-contact member, it is possible to reliably eliminate the thrust force as long as the press-contact member is supported slidably in the direction of the center axis with respect to the rotary shaft or the support body.

According to such an aspect of the invention, it is possible to bring the press-contact member into press-contact with the contact surfaces by supplying a pressurized fluid to the press-contact member to cause the diaphragm to expand. Further, it is possible to restore an original shape of the diaphragm and cancel the press-contact with the contact surfaces by discharging the pressurized fluid from the press-contact member. Such a diaphragm-based press-contact member can be simplified in structure and also improved in maintainability.

According to the aspect of the invention, a flattened piston may be used as the press-contact member in addition to the diaphragm. For instance, a structure in which round recesses are formed in opposite surfaces of a flattened base material and the piston in a round plate shape is fitted therein is usable. Considering a sealing performance around the piston, a resin balloon may be housed inside and hydraulic oil may be supplied into the balloon. Such a press-contact member facilitates an advancing/retreating stroke of the piston, which enables reliable clamping even when a space between the press-contact member and the contact surfaces is relatively large.

A plate-shaped piezoelectric element may be used as the press-contact member. For instance, a structure in which plate-shaped piezoelectric elements are fixed to opposite surfaces of a flattened base material is usable. With the use of such a press-contact member, the piezoelectric elements are caused to expand to be brought into press-contact with the contact surfaces through applied voltage control, resulting in a simpler structure than that when a fluid is used.

According to the aspect of the invention, it is possible to provide a rotary shaft clamp device that ensures restraining force and positional accuracy with a simple structure.

### BRIEF DESCRIPTION OF DRAWINGS

FIG. 1 is a front view of a main shaft head of a first exemplary embodiment of the invention.

FIG. 2 is a side view of the main shaft head of the first exemplary embodiment.

FIG. 3 is a plan view of the main shaft head of the first exemplary embodiment.

FIG. 4 is a cross-sectional view of a rotary shaft clamp device of the first exemplary embodiment.

FIG. 5 is a cross-sectional view of a press-contact member of the first exemplary embodiment.

FIG. 6 is a cross-sectional view of another press-contact member of the first exemplary embodiment.

FIG. 7 is a cross-sectional view of still another press-contact member of the first exemplary embodiment.

FIG. 8 is a cross-sectional view of a further press-contact member of the first exemplary embodiment.

FIG. 9 is a cross-sectional view of a rotary shaft clamp device of a second exemplary embodiment of the invention.

FIG. 10 is a cross-sectional view of a rotary shaft clamp device of a third exemplary embodiment of the invention.

FIG. 11 is a cross-sectional view of a rotary shaft clamp device of a fourth exemplary embodiment of the invention.

### DESCRIPTION OF EMBODIMENT(S)

### First Exemplary Embodiment

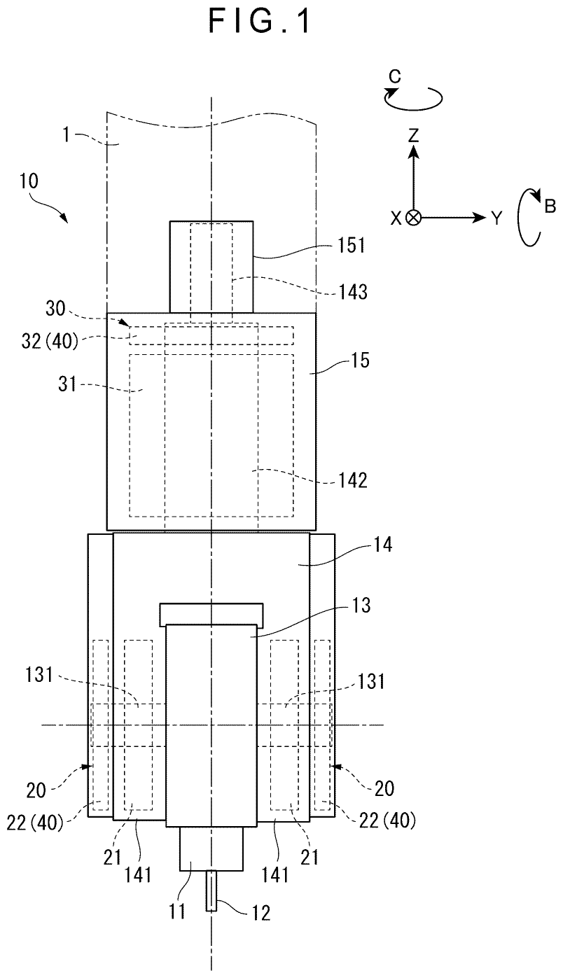

FIG. 1 to FIG. 3 illustrate a five-axis head 10 for a five-axis working machine. The five-axis head 10, which is configured to rotate an edged tool 12 attached to a main shaft 11 to machine a workpiece, is to be attached to a non-illustrated working machine and movable in three axis directions, X, Y, and Z. Further, the five-axis head 10 includes a B-axis rotation dividing device 20 and a C-axis rotation dividing device 30, so that an orientation of the main shaft 11 is turnable in two axes, a B-axis (around a Y-axis) and a C-axis (around a Z-axis).

The five-axis head 10 includes a spindle head 13, an arm body 14, and a head body 15.

The head body 15 is formed in a rectangular box shape and is attachable, on an upper surface side, to a ram 1 of the working machine via a non-illustrated fastening mechanism.

The arm body 14 is cut along the X-axis from a lower side of the rectangular box shape and has a lower portion in a form of a pair of arms 141. A rotary shaft 142 is coupled to an upper surface of the arm body 14. The rotary shaft 142 is rotatably supported by the head body 15.

The spindle head 13 is disposed between the pair of arms 141.

The spindle head 13 is in a cylindrical shape with a center axis along the Y-axis and opposite end surfaces thereof are coupled to respective rotary shafts 131 extending along the center axis of the spindle head 13. The pair of rotary shafts 131 extend into the pair of arms 141 and are rotatably supported by the respective arms 141.

The spindle head 13, by which the above-described main shaft 11 is rotatably supported, includes a non-illustrated main shaft motor that causes the main shaft 11 to rotate.

A slip ring casing 151 is installed on an upper surface of the head body 15. A slip ring rotary shaft 143 is coupled to an upper end of the rotary shaft 142. The slip ring rotary shaft 143 is introduced into the slip ring casing 151 and a slip ring is formed inside the slip ring casing 151. Electric wiring, piping, and the like to the above-described main shaft motor and the later-described B-axis rotation dividing device 20 and C-axis rotation dividing device 30 are rotatably coupled to the ram 1 side through the slip ring inside the slip ring casing 151.

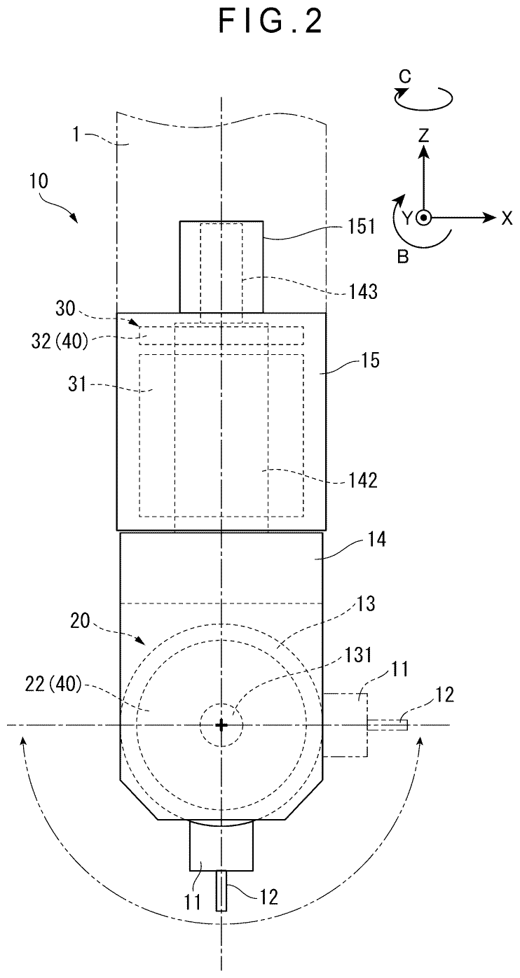

The arms 141 are each installed with, as the B-axis rotation dividing device 20, a driving motor 21 and a clamp device 22. The driving motors 21 provided as a pair cause the respective rotary shafts 131 to rotate, thereby enabling an orientation of the main shaft 11 to be changed to a desired angular position in the B-axis (see FIG. 2). The clamp devices 22 provided as a pair can restrain and clamp the rotary shafts 131 in a state where the spindle head 13 is at a desired angular position in the B-axis relative to the arm body 14.

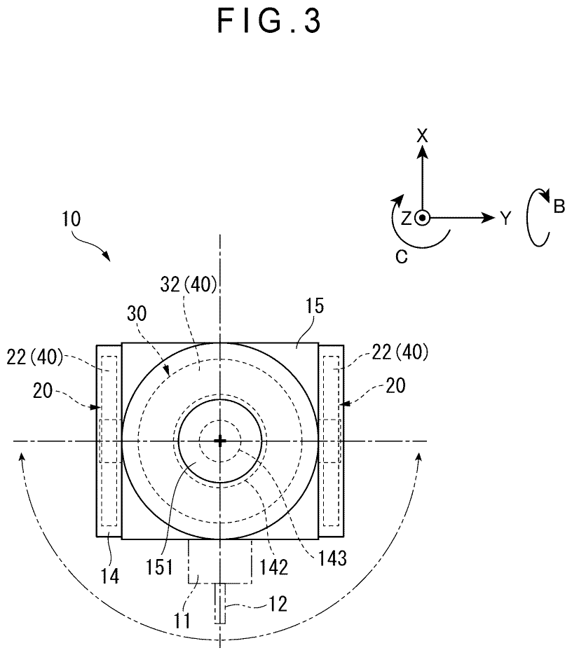

The head body 15 is installed with, as the C-axis rotation dividing device 30, a driving motor 31 and a clamp device 32. The driving motor 31 causes the rotary shaft 142 to rotate, thereby enabling an orientation of the arm body 14 to be changed to a desired angular position in the C-axis (see FIG. 3). The clamp device 32 can restrain and clamp the rotary shaft 142 in a state where the arm body 14 is at a desired angular position in the C-axis relative to the head body 15.

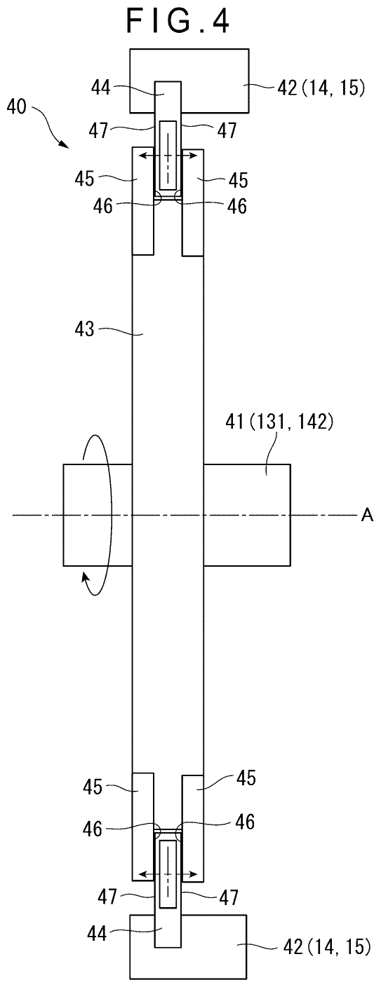

In the exemplary embodiment, a clamp device 40 illustrated in FIG. 4 is used as the clamp device 22 of the B-axis rotation dividing device 20 and the clamp device 32 of the C-axis rotation dividing device 30.

A rotary shaft 41 for the clamp device 40 in FIG. 4 corresponds to the rotary shaft 131 for the clamp device 22 or the rotary shaft 142 for the clamp device 32. In addition, a support body 42 corresponds to the arm body 14 for the clamp device 22 and the head body 15 for the clamp device 32.

The clamp device 40 includes a disk 43 fixed to an intermediate portion of the rotary shaft 41 (a first member) and a press-contact member 44 supported by the support body 42 (a second member).

Respective annular contact members 45 are fixed at opposite surface sides of the outer periphery of the disk 43. The contact members 45 provided as a pair are opposed at a predetermined space in a direction of a center axis A of the rotary shaft 41, and contact surfaces 46 provided as a pair are formed in respective opposed surfaces of the contact members 45. The contact surfaces 46 provided as a pair are annularly formed at a predetermined distance from the center axis A of the rotary shaft 41 and opposed to each other at a regular interval.

The press-contact member 44 is formed annularly and flatwise toward the center axis and concentrically arranged fully around an outer side of the disk 43 (see FIG. 3). The press-contact member 44 is partially located between the pair of contact surfaces 46. The press-contact member 44 has a front-back pair of surfaces 47 facing the contact surfaces 46. The pair of surfaces 47 are able to advance in directions along the center axis A of the rotary shaft 41.

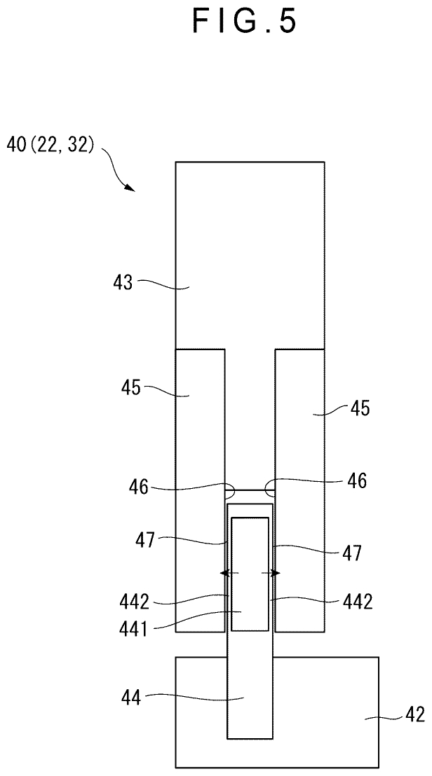

In FIG. 5, a member usable as the press-contact member 44 is flattened as a whole and has a cavity 441 inside and the opposite surfaces 47 that are diaphragms 442. In such a press-contact member 44, a pressurized fluid is supplied from the outside to the inner cavity 441 to cause the diaphragms 442 to expand by a fluid pressure, which makes it possible to bring the surfaces 47 into press-contact with the contact surfaces 46.

As long as the press-contact member 44 is disposed at an equal distance from the contact surfaces 46 provided as a pair, the opposite diaphragms 442 equally expand by the supply of the pressurized fluid and the opposite surfaces 47 simultaneously come into contact with the contact surfaces 46 provided as a pair to be equally in press-contact therewith.

As a result, the contact members 45 are restrained by the press-contact member 44 with the assistance of friction force between the surfaces 47 and the contact surfaces 46 to clamp the rotary shaft 41 with respect to the support body 42. At this time, the pressure contact force applied from one of the surfaces 47 to the facing contact surface 46 and the pressure contact force applied from the other of the surfaces 47 to the facing contact surface 46 act in opposite directions, and thus cancel each other out. Thus, there is no displacement of the rotary shaft 41 relative to the support body 42.

In contrast, in a case where the press-contact member 44 is deviated (biased) to one of the contact surfaces 46 provided as a pair, the respective surfaces 47 on the opposite sides come into press-contact with the contact surfaces 46 in sequence.

Specifically, as the diaphragms 442 expand by the supply of the pressurized fluid, the surface 47 on the deviation side first comes into contact with the facing contact surface 46, inhibiting the diaphragm 442 from expanding. The diaphragm 442 on the side opposite the deviation side continues to expand.

In a state where the surface 47 is in press-contact with the contact surface 46 only on the deviation side, the press-contact force on this side acts on the rotary shaft 41. However, the press-contact force at this stage is bearable for a rotation support structure including the support body 42 for the rotary shaft 41 and thus causes no displacement of the rotary shaft 41.

A subsequent supply of the pressurized fluid causes the surface 47 on the side opposite the deviation side to come into contact with the facing contact surface 46, inhibiting the diaphragm 442 from expanding. Then, as the pressurized fluid is further pneumatically delivered, the surfaces 47 come into press-contact with the respective facing contact surfaces 46 with the diaphragms 442 in between on the opposite sides.

Accordingly, as in the case where the press-contact member 44 is disposed at the equal distance, the contact members 45 are restrained by the press-contact member 44 with the assistance of the friction force between the surfaces 47 and the contact surfaces 46 on the opposite sides to clamp the rotary shaft 41 with respect to the support body 42. At this time, the pressure contact force applied from one of the surfaces 47 to the facing contact surface 46 and the pressure contact force applied from the other of the surfaces 47 to the facing contact surface 46 act in opposite directions, and thus cancel each other out. Thus, there is no displacement of the rotary shaft 41 relative to the support body 42.

Therefore, the clamp device 40 of the exemplary embodiment may have a basic configuration similar to that of an existing disk-based clamp device. It is possible to restrain the rotary shaft 41 with respect to the support body 42 by virtue of the press-contact of the press-contact member 44 with the contact surfaces 46 and ensure restraining force by virtue of a large distance from the rotary shaft 41 to the press-contact member 44 provided by an outer diameter of the disk 43.

Further, in the exemplary embodiment, the press-contact member 44 is disposed between the pair of contact surfaces 46 formed in the outer periphery of the disk 43, making it possible to simplify the structure as the clamp device 40. Further, the press-contact member 44 comes into press-contact with the inner side of each of the contact surfaces 46 provided as a pair to equalize the contact force to the contact surfaces 46. Thus, no force (thrust force) in the direction of the center axis A attributed to the press-contact is generated in the rotary shaft 41, making it possible to ensure positional accuracy as rotation mechanisms, or the B-axis rotation dividing device 20 and the C-axis rotation dividing device 30.

Further, the two B-axis rotation dividing devices 20 are installed in respective opposite end portions of the arm body 14, and thus maintenance, inspection, or the like is easily performed by opening an end portion cover of the arm body 14.

### Another Exemplary Embodiment of Piezoelectric Element

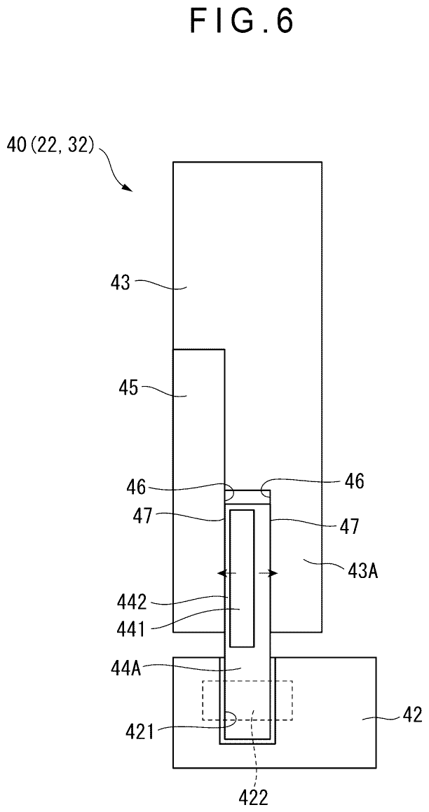

In the exemplary embodiment, press-contact members 44A to 44C illustrated in FIG. 6 to FIG. 8 are also usable in place of the press-contact member 44 in FIG. 5.

In FIG. 6, the press-contact member 44A is flattened as a whole and has the cavity 441 inside. The cavity 441 is deviated (biased) to one surface of the press-contact member 44A and only one of the opposite surfaces 47 is the diaphragm 442. The press-contact member 44A is fitted in a recess 421 formed in the support body 42. A pin 422 extending in an axis direction of the rotary shaft 41 penetrates through the press-contact member 44A. The press-contact member 44A is thus displaceable in the axis direction of the rotary shaft 41 while being restricted from moving in a rotation direction of the rotary shaft 41.

In such a press-contact member 44A, a pressurized fluid is supplied from the outside to the inner cavity 441 to cause the diaphragm 442 to expand by a fluid pressure, so that the one of the surfaces 47 comes into press-contact with the facing contact surface 46. A further supply of the pressurized fluid causes the press-contact member 44A to be displaced with the diaphragm 442 expanding, so that the surface 47 on the opposite side also comes into press-contact with the facing contact surface 46. The opposite surfaces 47 thus come into press-contact with the respective contact surfaces 46 provided as a pair, and a further supply of the pressurized fluid makes it possible to ensure sufficient restraining force. No force (no thrust force) in the direction of the center axis A attributed to the press-contact is generated in the rotary shaft 41.

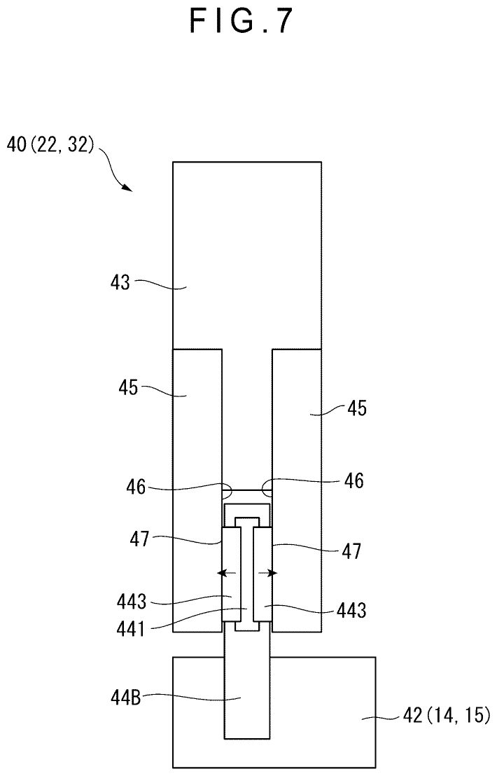

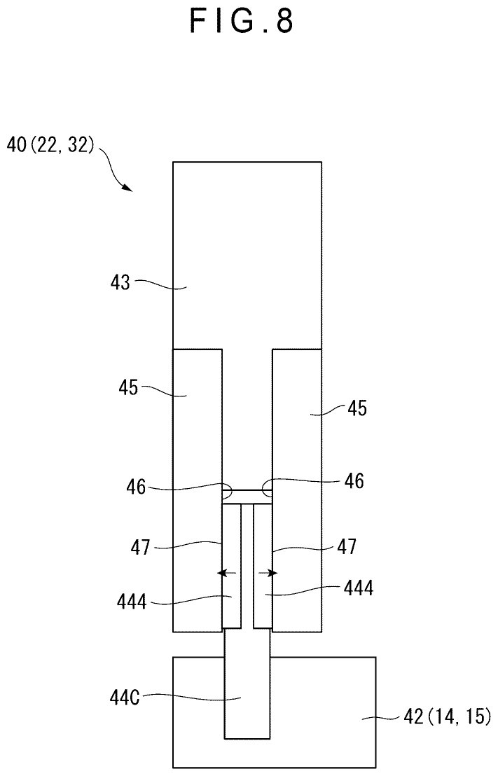

In the clamp device 40 in FIG. 6, the contact member 45 is disposed on one side of the press-contact member 44A and a contact portion 43A, which is an extension of a part of the disk 43, is disposed on the opposite side. In such a structure, the press-contact member 44A can be introduced in between the pair of contact surfaces 46 by removing the contact member 45 from the disk 43. The same applies to the clamp devices 40 in FIG. 5 described above and FIG. 7 and FIG. 8 described later.

In FIG. 7, a press-contact member 44B is flattened as a whole and has the cavity 441 inside and the opposite surfaces 47 formed by flattened pistons 443. In such a press-contact member 44B, a pressurized fluid is supplied from the outside to the inner cavity 441 to cause the pistons 443 to advance by a fluid pressure, which makes it possible to bring the surfaces 47 into press-contact with the contact surfaces 46.

In FIG. 8, a press-contact member 44C is in a form of a flattened plate as a whole and has the opposite surfaces 47 formed by flattened piezoelectric elements 444. In such a press-contact member 44C, the piezoelectric elements 444 are caused to expand by voltage application to the piezoelectric elements 444, which makes it possible to bring the surfaces 47 into press-contact with the contact surfaces 46.

### Second Exemplary Embodiment

A second exemplary embodiment is the five-axis head 10 for a five-axis working machine similar to that of the first exemplary embodiment, except that the clamp device 40 is different in configuration. Description will be made below on a configuration different from that of the first exemplary embodiment.

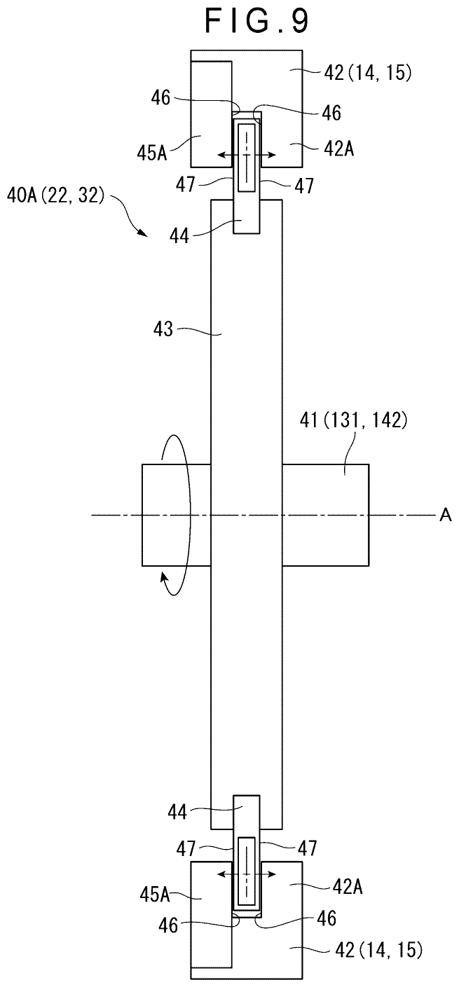

FIG. 9 illustrates a clamp device 40A of the second exemplary embodiment.

In the clamp device 40 of the first exemplary embodiment, the pair of contact surfaces 46 are formed in the disk 43 fixed to the rotary shaft 41 and the press-contact member 44 is supported by the support body 42.

In contrast, in the clamp device 40A of the second exemplary embodiment, the arrangement of the press-contact member 44 and the pair of contact surfaces 46 relative to the rotary shaft 41 and the support body 42 is inverted.

In FIG. 9, the support body 42 is provided with an annular groove in a cylindrical inner peripheral surface and opposed surfaces inside thereof serve as the pair of contact surfaces 46. The contact surfaces 46 provided as a pair are annularly formed at a predetermined distance from the center axis A of the rotary shaft 41 and opposed to each other at a predetermined interval in the direction of the center axis A. The groove forming the pair of contact surfaces 46 is defined by, on one side, a contact portion 42A continuous from the support body 42 and, on the opposite side, an annular contact member 45A removably fixed to the support body 42.

The press-contact member 44 is radially outwardly fixed to the outer periphery of the disk 43 and extends in between the pair of contact surfaces 46. The press-contact member 44 is introducible into the groove in a state where the contact member 45A is removed from the support body 42.

The press-contact member 44 has the configuration in FIG. 5 or any of the configurations in FIG. 6 to FIG. 8 (the press-contact members 44A to 44C) described above, and the front-back pair of surfaces 47 facing the contact surfaces 46 are configured to advance in directions along the center axis A of the rotary shaft 41.

In such an exemplary embodiment, it is possible to restrain the rotary shaft 41 with respect to the support body 42 without any displacement by causing the opposite surfaces 47 of the press-contact member 44 to advance and come into press-contact with the pair of contact surfaces 46. The restraining force and the positional accuracy can thus be ensured with a simple structure.

### Third Exemplary Embodiment

A third exemplary embodiment is the five-axis head 10 for a five-axis working machine similar to that of the first exemplary embodiment, except that the clamp device 40 is different in configuration. Description will be made below on a configuration different from that of the first exemplary embodiment.

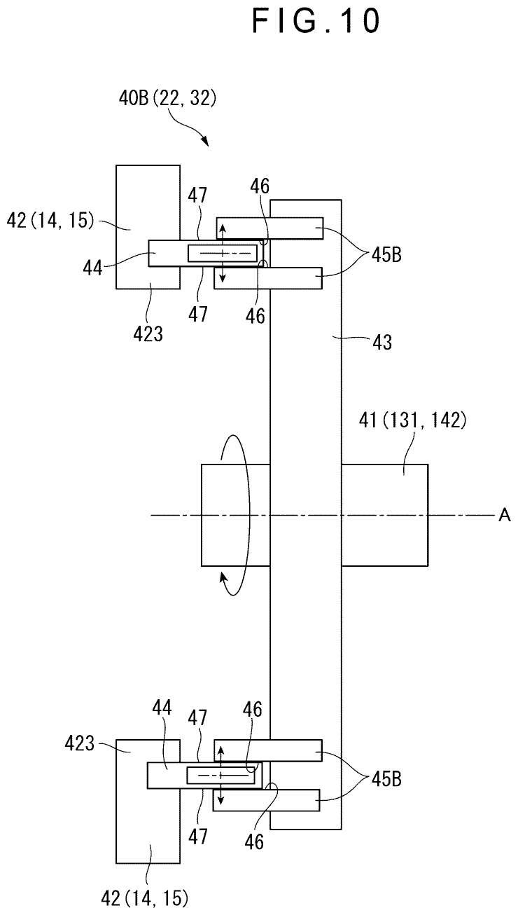

FIG. 10 illustrates a clamp device 40B of the third exemplary embodiment.

In the clamp device 40 of the first exemplary embodiment, the pair of contact surfaces 46 in the outer periphery of the disk 43 fixed to the rotary shaft 41 and the surfaces 47 of the press-contact member 44 supported by the support body 42 are arranged along a radial direction of the rotary shaft 41.

In the clamp device 40B of the third exemplary embodiment, the surfaces 47 of the press-contact member 44 and the pair of contact surfaces 46 are arranged along a direction intersecting with the radial direction of the rotary shaft 41, that is, a circumferential direction of the rotary shaft 41.

In FIG. 10, a pair of contact members 45B are fixed to one surface of the disk 43 near the outer periphery thereof. The contact members 45B provided as a pair are concentrically arranged with respect to the center axis A of the rotary shaft 41, and the contact surfaces 46 provided as a pair are formed in respective opposed surfaces of the contact members 45B. The contact surfaces 46 provided as a pair are annularly formed at a predetermined distance from the center axis A of the rotary shaft 41 and opposed to each other at a regular interval.

The press-contact member 44 is supported by an inner flange 423 projecting from an inner side of the support body 42 and extends in the direction of the center axis A of the rotary shaft 41 to a space between the pair of contact surfaces 46.

The press-contact member 44 has the configuration in FIG. 5 or any of the configurations in FIG. 6 to FIG. 8 (the press-contact members 44A to 44C) described above, and the front-back pair of surfaces 47 facing the contact surfaces 46 are configured to advance in directions along the center axis A of the rotary shaft 41.

In such an exemplary embodiment, it is possible to restrain the rotary shaft 41 with respect to the support body 42 without any displacement by causing the opposite surfaces 47 of the press-contact member 44 to advance and come into press-contact with the pair of contact surfaces 46. The restraining force and the positional accuracy can thus be ensured with a simple structure.

### Fourth Exemplary Embodiment

A fourth exemplary embodiment is the five-axis head 10 for a five-axis working machine similar to that of the first exemplary embodiment, except that the clamp device 40 is different in configuration. Description will be made below on a configuration different from that of the first exemplary embodiment.

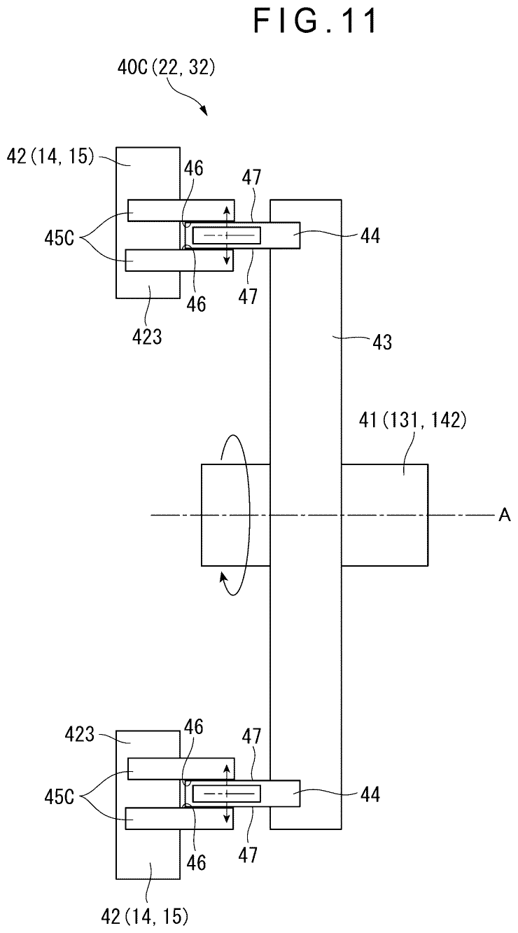

FIG. 11 illustrates a clamp device 40C of the fourth exemplary embodiment.

In the clamp device 40 of the first exemplary embodiment, the pair of contact surfaces 46 in the outer periphery of the disk 43 fixed to the rotary shaft 41 and the surfaces 47 of the press-contact member 44 supported by the support body 42 are arranged along a radial direction of the rotary shaft 41.

In the clamp device 40C of the fourth exemplary embodiment, the surfaces 47 of the press-contact member 44 and the pair of contact surfaces 46 are arranged along a direction intersecting with the radial direction of the rotary shaft 41, that is, the circumferential direction of the rotary shaft 41. Further, the arrangement of the press-contact member 44 and the pair of contact surfaces 46 relative to the rotary shaft 41 and the support body 42 is inverted.

In FIG. 11, a pair of contact members 45C are fixed to one surface of the inner flange 423 projecting from the inner side of the support body 42. The contact members 45C provided as a pair are concentrically arranged with respect to the center axis A of the rotary shaft 41, and the contact surfaces 46 provided as a pair are formed in respective opposed surfaces of the contact members 45C. The contact surfaces 46 provided as a pair are annularly formed at a predetermined distance from the center axis A of the rotary shaft 41 and opposed to each other at a regular interval.

The press-contact member 44 is supported on one surface of the disk 43 near the outer periphery thereof and extends in the direction of the center axis A of the rotary shaft 41 to a space between the pair of contact surfaces 46.

The press-contact member 44 has the configuration in FIG. 5 or any of the configurations in FIG. 6 to FIG. 8 (the press-contact members 44A to 44C) described above, and the front-back pair of surfaces 47 facing the contact surfaces 46 are configured to advance in directions along the center axis A of the rotary shaft 41.

In such an exemplary embodiment, it is possible to restrain the rotary shaft 41 with respect to the support body 42 without any displacement by causing the opposite surfaces 47 of the press-contact member 44 to advance and come into press-contact with the pair of contact surfaces 46. The restraining force and the positional accuracy can thus be ensured with a simple structure.

### Other Exemplary Embodiments

It should be noted that the invention is not limited to the above-described exemplary embodiments but includes modifications and the like as long as such modifications and the like are compatible with the object of the invention.

In each of the exemplary embodiments, the contact members 45 or the press-contact member 44 are supported at the outer periphery of the disk 43 fixed to the rotary shaft 41, but these may be supported by radial spokes or the like instead of the disk 43. Further, the contact members 45 are not necessarily arranged on the opposite sides of the press-contact member 44, and the contact portion 43A may be formed integrally with the disk 43 on one of the opposite sides. Furthermore, the annular contact members 45 supported by the support body 42 may be replaced by the annular contact portions 42A formed integrally with the support body 42. The contact surfaces 46 provided as a pair are not necessarily the surfaces facing the inner sides of the contact members 45 provided as a pair, and may be in a form of an internal surface of an annular groove. Further, the press-contact member 44 may also be formed integrally with the support body 42 or the disk 43.

In each of the exemplary embodiments, the press-contact members 44, 44A, 44B, and 44C are each flattened and annular, but not necessarily annularly continuous. A plurality of discontinuous press-contact members may be arranged in the circumferential direction at regular intervals.

In each of the exemplary embodiments, the two B-axis rotation dividing devices 20 are installed on the B-axis rotary shafts 131 and the single C-axis rotation dividing device 30 is installed on the C-axis rotary shaft 142. However, the number of the devices 20 and 30 may be any number equal to or more than one.

Further, each B-axis rotation dividing device 20 is installed with the single clamp device 22, and the C-axis rotation dividing device 30 is installed with the single clamp device 32 in the above exemplary embodiments. However, each of the devices 20 and 30 may be installed with a plurality of arrays of the clamp device.

In each of the above exemplary embodiments, the rotary shaft clamp device of the invention is applied to the B-axis rotation dividing devices 20 and the C-axis rotation dividing device 30 of the five-axis head 10 for a five-axis working machine. However, the rotary shaft clamp device of the invention may be applied to a worktable rotation mechanism for a working machine, or the like.

### INDUSTRIAL APPLICABILITY

The invention is applicable to a rotary shaft clamp device.

### EXPLANATION OF CODES

1 . . . ram, 10 . . . five-axis head, 11 . . . main shaft, 12 . . . edged tool, 13 . . . spindle head, 131 . . . rotary shaft, 14 . . . arm body, 141 . . . arm, 142 . . . rotary shaft, 143 . . . slip ring rotary shaft, 15 . . . head body, 151 . . . slip ring casing, 20 . . . . B-axis rotation dividing device, 21, 31 . . . driving motor, 22, 32, 40, 40A, 40B, 40C . . . clamp device, 30 . . . . C-axis rotation dividing device, 41 . . . rotary shaft, 42 . . . support body, 421 . . . recess, 422 . . . pin, 423 . . . inner flange, 43 . . . disk, 44, 44A, 44B, 44C . . . press-contact member, 441 . . . cavity, 442 . . . diaphragm, 443 . . . piston, 444 . . . piezoelectric element, 45, 45B, 45C . . . contact member, 42A, 43A . . . contact portion, 46 . . . contact surface, 47 . . . surface, A . . . center axis.

1. A rotary shaft clamp device configured to clamp a first member to a second member, the first and second members being relatively rotatable around a predetermined center axis, the rotary shaft clamp device comprising:
a pair of contact surfaces supported by the first member, the pair of contact surfaces being annularly formed at a predetermined distance from the center axis and opposed to each other at a regular interval; and
a press-contact member supported by the second member, the press-contact member being configured to come into press-contact with the pair of contact surfaces, the press-contact member having a pair of surfaces located between the pair of contact surfaces to face the contact surfaces, the pair of surfaces being configured to advance in directions along the center axis.

2. The rotary shaft clamp device according to claim 1, wherein:
the first member comprises a rotary shaft;
the second member comprises a support body by which the rotary shaft is rotatably supported;
a disk is concentrically formed at an intermediate portion of the rotary shaft;
the pair of contact surfaces are formed in an outer periphery of the disk and opposed in a direction of the center axis; and
the press-contact member is supported by the support body.

3. The rotary shaft clamp device according to claim 1, wherein:
the first member comprises a support body;
the second member comprises a rotary shaft rotatably supported by the support body;
an annular contact member is formed on an inner side of the support body, the contact member being concentric with the rotary shaft;
the pair of contact surfaces are formed in an inner periphery of the contact member and opposed in a direction of the center axis; and
the press-contact member is supported by the rotary shaft.

4. The rotary shaft clamp device according to claim 1, wherein;
the first member comprises a rotary shaft;
the second member comprises a support body by which the rotary shaft is rotatably supported;
a disk is concentrically formed at an intermediate portion of the rotary shaft;
the pair of contact surfaces are formed in an outer edge of the disk and opposed in a radial direction of the rotary shaft; and
the press-contact member is supported by the support body.

5. The rotary shaft clamp device according to claim 1, wherein:
the first member comprises a support body;
the second member comprises a rotary shaft rotatably supported by the support body;
an annular contact member is formed on an inner side of the support body, the contact member being concentric with the rotary shaft;
the pair of contact surfaces are formed in an inner edge of the contact member and opposed in a radial direction of the rotary shaft; and
the press-contact member is supported by the rotary shaft.

6. The rotary shaft clamp device according to claim 1, wherein the press-contact member is flattened and comprises a diaphragm expandable by a fluid pressure supplied inside.

7. The rotary shaft clamp device according to claim 2, wherein the press-contact member is flattened and comprises a diaphragm expandable by a fluid pressure supplied inside.

8. The rotary shaft clamp device according to claim 3, wherein the press-contact member is flattened and comprises a diaphragm expandable by a fluid pressure supplied inside.

9. The rotary shaft clamp device according to claim 4, wherein the press-contact member is flattened and comprises a diaphragm expandable by a fluid pressure supplied inside.

10. The rotary shaft clamp device according to claim 5, wherein the press-contact member is flattened and comprises a diaphragm expandable by a fluid pressure supplied inside.
